(19) United States
(12) Patent Application Publication
(10) Pub. No.: US 2010/0287079 A1
(43) Pub. Date: Nov. 11, 2010

(54) CHARGING IN IMS NETWORKS FOR SESSIONS THAT ARE TRANSFERRED BETWEEN ACCESS NETWORKS

(76) Inventors: Yigang Cai, Naperville, IL (US); YuDong Li, Beijing (CN); Ke Pei, Beijing (CN); Chunguang Xu, Beijing (CN)

Correspondence Address: DUFT BORNSEN & FISHMAN, LLP, 1526 SPRUCE STREET, SUITE 302, BOULDER, CO, 80302, US

(21) Appl. No.: 12/808,108

(22) PCT Filed: Dec. 18, 2007
(86) PCT No.: PCT/US07/87985

§ 371 Date: Jun. 14, 2010

(51) Int. Cl. G06Q 30/00; H04W 36/16

(52) U.S. Cl. 705/34; 370/331

(57) ABSTRACT

IMS networks and methods are disclosed for charging for a session of a dual mode device that is transferred (seamless handover) from a first access network to a second access network. When a session is transferred between access networks, multiple charging identifiers (e.g., ICID) are assigned to the session. One or more network elements in the IMS network identify both an original ICID and a handover ICID for the session, and insert the original and handover ICID in a charging message that is transmitted to a charging system. The charging system then inserts the original ICID and the handover ICID in a CDR for the session. When the session ends, the charging system may use the original ICID and the handover ICID to correlate multiple CDRs for the session. Thus, even if CDRs for the same session have different ICIDs, the charging system is able to correlate the CDRs.

### RELATED APPLICATIONS

This application is the National Stage under 35 U.S.C. 371 of International Application No. PCT/US07/87985, filed Dec. 18, 2010, which is incorporated by reference herein.

### BACKGROUND OF THE INVENTION

1. Field of the Invention

The invention is related to the field of communication networks and, in particular, to providing for offline charging in IMS networks for sessions of dual mode devices that are transferred between access networks (e.g., a session transferred (seamlessly handed over) from a GSM network to a WiFi network).

2. Statement of the Problem

One type of communication network gaining popularity is an IP Multimedia Subsystem (IMS) network. As set forth in the 3^{rd} Generation Partnership Project (3GPP), IMS provides a common core network having a network architecture that allows for various types of access networks. The access network between a communication device and the IMS network may be a cellular network (e.g., CDMA or GSM), a WLAN (e.g., WiFi or WiMAX), an Ethernet network, or another type of wireless or wireline access network. The IMS architecture is initially defined by the 3GPP to provide multimedia services to communication devices over an Internet Protocol (IP) network, as IP networks have become the most cost savings bearer network to transmit video, voice, and data. Service providers are accepting this architecture in next generation network evolution.

For a typical session (or call) within an IMS network, user equipment of an IMS subscriber initiates the session through an access network, such as a CDMA network, a GSM network, an IP network, a WiFi network, a WiMAX network, etc, by transmitting the appropriate signaling messages (i.e., SIP messages). The access network then routes the signaling messages to the IMS network. If the access network does not use the same signaling protocols as the IMS network (e.g., SIP), then the access network may route the signaling messages to the IMS network through an appropriate gateway. A serving-call session control function (S-CSCF) in the IMS network receives the signaling messages and attempts to establish the session in the appropriate manner. When the session is established, the S-CSCF may also contact one or more application servers (AS) in the IMS network to provide services for the session, such as voicemail, call forwarding, etc.

To provide offline charging for the session, each of the IMS network elements (e.g., S-CSCF and AS) handling the session generates charging messages typically in Diameter Rf protocol. For instance, a network element transmits a start charging message, such as a Diameter Accounting Request (ACR[start]) message, to a Charging Data Function (CDF) in the IMS network at an initial triggering event. Periodically during the session, the network element transmits interim charging messages, such as a Diameter ACR[interim] messages, to the CDF. At ending triggering event, the network element transmits a stop charging message, such as a Diameter ACR[stop] message, to the CDF. Each of the charging messages includes an IMS Charging Identifier (ICID) that is assigned to the session so that the charging messages may be correlated in the CDF.

The CDF then processes the charging messages received from the network elements that are serving the session to generate Charging Data Records (CDR) for the session. The CDF then transmits the CDRs to a Charging Gateway Function (CGF) that correlates the CDRs that have been generated for the session based on the ICID. The CGF then transmits the correlated CDRs to a billing system. The billing system may then resolve any charging for the session based on the correlated CDRs.

Some service providers allow for dual mode service. Dual mode service allows an IMS device to communicate with different types of access networks that utilize different protocols. As an example, dual mode service may allow an IMS device to communicate with a cellular network, such as a CDMA network or a GSM network, and also communicate with a wireless LAN, such as a WiFi network or WiMAX network. IMS devices that are able to receive a dual mode service are referred to as dual mode devices or dual mode handsets.

When a dual mode device initiates or accepts a session over a first access network (for example a non-IMS network, such as a GSM network), the mobile management application and network domain selection function which may reside in a dual mode handover application server or an independent server will communicate with an S-CSCF, and change the request-URI. The S-CSCF in the IMS network receives the session initiation message and establishes the session with a destination. A first session leg is then established between the dual mode device and the destination with the first access network acting as the access network for the IMS network. In response to the first session leg being established, an ICID is assigned to the session, which is referred to herein as an original ICID. The S-CSCF and other network elements serving the session generate charging messages as described above that include the original ICID.

If the dual mode device transfers to a second access network, such as a WiFi network, then the dual mode device transmits another session initiation message (e.g., another SIP INVITE message) to the IMS network through the second access network. When a dual mode device transfers from one access network to another access network, this is often referred to as a “handover”. The S-CSCF in the IMS network receives the new session initiation message, and forwards the message to a handover application server. The handover application server operates to establish a second session leg between the dual mode device and the destination with the second access network acting as the access network for the IMS network. The handover application server establishes the second session leg so that the session is not interrupted in the handover to the second access network. The end user keeps the session when actually the session is seamlessly handed over from the first access network to the second access network. The end user may not notice the handover during the session. The first session leg is also torn down.

In response to the second session leg being established, another ICID is assigned to the session, which is referred to herein to as a handover ICID. The S-CSCF and other network elements serving the session generate additional charging messages as described above that include either the handover ICID or the original ICID depending on the dialog that triggers the charging message. Thus, the CDF receiving the charging messages for the session will generate CDRs with the original ICID and will also generate CDRs with the handover ICID.

One problem in present IMS networks is that there is no effective way to correlate CDRs for a session when there was a handover from one access network to another access network. When there are multiple handovers during one session or call, many different ICIDs are generated. The CDRs for the same session will have different ICIDs when it is handed over from one access network to another. Thus, the CGF is not able to correlate the CDR for the session. As a result, the end user may be under-billed or over-billed for the session.

### SUMMARY OF THE SOLUTION

Embodiments of the invention solve the above and other related problems by having a network element in the IMS network, such as a handover application server, identify not only the original ICID but also the handover ICID for a session that has been handed off from one access network to another. When charging is triggered in the network element, the network element inserts the handover ICID and possibly other handover information in the charging messages along with the original ICID. The charging system (e.g., CDF/CGF) that receives the charging messages may then generate a CDR for the session that includes the original ICID and the handover ICID. If multiple CDRs are generated for the session, then the charging system is able to correlate the CDRs based on the original ICID and the handover ICID. As a result, the end user is advantageously billed the correct amount because the CDRs for the session are accurately correlated.

One embodiment comprises an IMS network adapted to provide charging for a session of a dual mode device that is transferred from a first access network to a second access network. The IMS network includes a network element, such as an S-CSCF or a handover application server, and a charging system. The network element identifies a triggering event for charging during the session, and identifies a transfer of the session from the first access network to the second access network. With the session being transferred from the first access network to the second access network, the network element identifies a handover charging identifier (e.g., handover ICID) assigned to the session over the second access network in addition to an original charging identifier assigned to the session over the first access network. The network element then generates a charging message (e.g., a Diameter ACR message) for the session and inserts the handover charging identifier and the original charging identifier in the charging message. The network element then transmits the charging message to the charging system.

The charging system receives the charging message from the network element, and processes the charging message to identify the original charging identifier and the handover charging identifier. The charging system then inserts the original charging identifier and the handover charging identifier in a Charging Data Record (CDR) for the session. At the end of the session, the charging system processes the original charging identifier and the handover charging identifier in the CDR to identify other CDRs for the session having at least one of the original charging identifier and the handover charging identifier. The charging system then correlates the CDRs for the session based on the original charging identifier and the handover charging identifier, and transmits the correlated CDRs to a billing system.

Because both the original charging identifier and the handover charging identifier are reported to the charging system and inserted in one or more CDRs, the charging system is able to identify CDRs for the same session even though the CDRs may have different charging identifiers. As a result, more accurate charging may be realized for the session.

The invention may include other exemplary embodiments described below.

### DESCRIPTION OF THE DRAWINGS

The same reference number represents the same element or same type of element on all drawings.

FIG. 1 illustrates a communication network in an exemplary embodiment of the invention.

FIG. 2 is a flow chart illustrating a method of generating charging messages in network elements in an IMS network in an exemplary embodiment of the invention.

FIG. 3 is a flow chart illustrating a method of processing charging messages in a charging system to generate CDRs in an exemplary embodiment of the invention.

FIG. 4 is a flow chart illustrating a method of correlating CDRs in a charging system in an exemplary embodiment of the invention.

FIG. 5 illustrates another communication network in an exemplary embodiment of the invention.

FIGS. 6-8 are message diagrams illustrating messaging used in a session over the communication network of FIG. 5 in an exemplary embodiment of the invention.

### DETAILED DESCRIPTION OF THE INVENTION

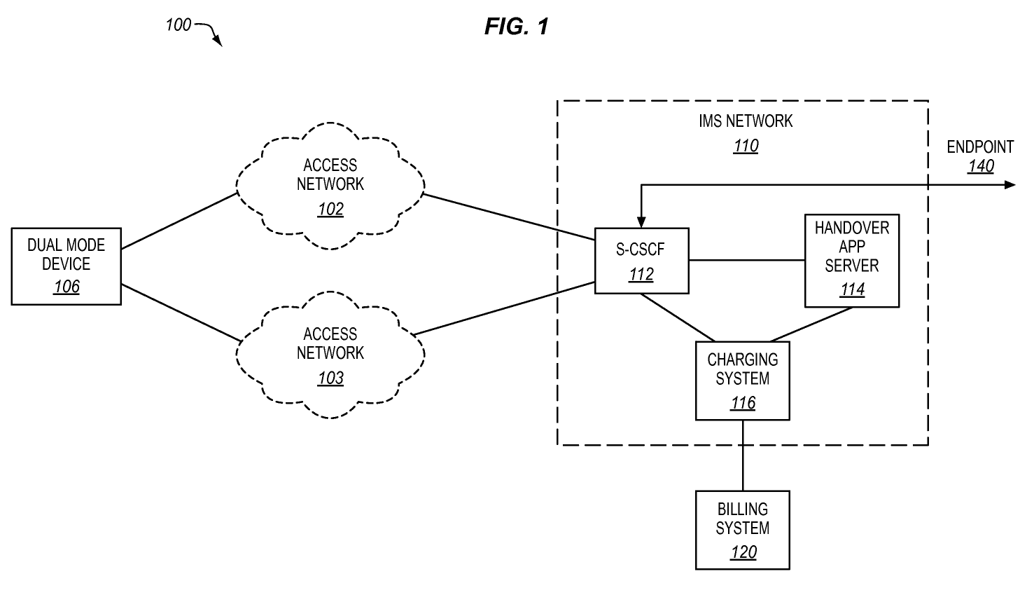

FIGS. 1-8 and the following description depict specific exemplary embodiments of the invention to teach those skilled in the art how to make and use the invention. For the purpose of teaching inventive principles, some conventional aspects of the invention have been simplified or omitted. Those skilled in the art will appreciate variations from these embodiments that fall within the scope of the invention. Those skilled in the art will appreciate that the features described below can be combined in various ways to form multiple variations of the invention. As a result, the invention is not limited to the specific embodiments described below, but only by the claims and their equivalents.

FIG. 1 illustrates a communication network 100 in an exemplary embodiment of the invention. Communication network 100 includes a first access network 102, a second access network 103, and an IMS network 110. IMS network 110 includes a serving-call session control function (S-CSCF) 112, a handover application server 114, and a charging system 116. Communication network 100 further includes a billing system 120 (which may actually be part of IMS network 110). IMS network 110 may include other network elements that are not shown for the sake of brevity, such as one or more proxy-call session control functions (P-CSCF), a BGCF (for a voice call to GSM and CDMA, the S-CSCF will route the call to BGCF first then BGCF routes to an MGCF), one or more media gateways, etc.

Access networks 102-103 comprises any networks that provide access to IMS network 110 using different protocols. For instance, access network 102 may comprise a cellular network, such as a CDMA network or a GSM network, while access network 103 comprises a wireless LAN, such as a WiFi network or WiMAX network. Each of access networks 102-103 may be wireline networks or wireless networks.

Access networks 102-103 are illustrated as providing service to a dual mode device 106. A dual mode device comprises any wireless and/or wireline device adapted to communicate with different types of access networks that utilize different protocols. Dual mode device 106 has the capability of communicating with either of access networks 102-103 in order to access IMS network 110 and its associated services, along with other access networks not shown in FIG. 1. Dual mode device 106 also has the capability of switching between access networks 102-103 during an established session.

Within IMS network 110, S-CSCF 112 comprises any system, server, or function adapted to establish, maintain, or tear down a session in IMS network 110. Handover application server (AS) 114 comprises any system, server, or function adapted to provide a handover service for a session of dual mode device 106. Typically, the handover application server 114 may be a Voice Call Continuity (VCC) application server adapted to provide voice call continuity when the user is moving between a Circuit Switched (CS) domain and an IMS domain. The handover application server or VCC application server may include a mobile management AS option (not shown) and a network domain selection function (not shown) to perform handover between different wireless domains. The mobile management AS is where the IMS core network emulates an MSC to a circuit-switched network for subscriber access on IMS network. The network domain selection function determines call delivery routing. The service logic of the network domain selection function routes the session to the appropriate domain (IMS or circuit-switched) based on the current state of registration within the domains and operator and subscriber preferences. Handover application server 114 processes signaling messages for the session to provide a handover from access network 102 to access network 103 (or vice-versa) without interruption of the session. Charging system 116 comprises any system, server, or function adapted to receive charging messages from network elements that are serving the session, such as S-CSCF 112 and handover application server 114, and to generate Charging Data Records (CDR) for the session. For example, charging system 116 may comprise a Charging Data Function (CDF)/Charging Gateway Function (CGF) as defined by the 3GPP in Release 6, or a Charging Collector Function (CCF) as defined by the 3GPP in Release 5. Billing system 120 comprises any system, server, or function adapted to process CDRs to generate or resolve a bill for a session in IMS network 110.

In this embodiment, assume that dual mode device 106 registers with IMS network 110 and has initiated or is invited into a session with an endpoint 140. Further assume that the session is initially over access network 102. Thus, a first session leg is established between dual mode device 106 and endpoint 140 using access network 102 as the means of access to IMS network 110.

At initiation of the session, a network element in IMS network 110 will assign a charging identifier to the session. A charging identifier comprises any number, code, string, etc, that is assigned in IMS network 110 and used to correlate charging information for the session. An example of a charging identifier is an IMS Charging Identifier (ICID). As an example of assigning a charging identifier, if dual mode device 106 initiates the session with a session initiation message (e.g., SIP INVITE), then a P-CSCF (not shown), a media gateway (not shown), or another element receiving the session initiation message will assign the charging identifier that is unique to that session. More particularly, the charging identifier is unique to the session leg. The charging identifier that is originally or initially assigned to the session is referred to herein as the original charging identifier.

When S-CSCF 112 receives a session initiation message (e.g., a SIP INVITE) for the session, which is initiated by either dual mode device 106 or endpoint 140, S-CSCF 112 processes initial filter criteria (iFC) for dual mode device 106 and identifies that dual mode device 106 has dual mode capabilities and may initiate a handover at some point during the session. S-CSCF 112 then transmits the appropriate signaling messages to handover application server 114 to include handover application server 114 in the session.

S-CSCF 112, handover application server 114, and other network elements (not shown) in IMS network 110 have Charging Trigger Functions (CTF) that are defined to provide offline charging for the session. When a CTF in a network element (e.g., S-CSCF 112 or handover application server 114) identifies a triggering event, the network element generates a charging message for the session. The charging message may be a start, interim, or stop message. As an example, the charging message may comprise an Accounting Request (ACR) [start, interim, stop] message as defined in Diameter Rf protocol. The network element inserts the original charging identifier in the charging message, along with other charging information, and then transmits the charging message to charging system 116.

Assume at some point that dual mode device 106 initiates a transfer of the session from access network 102 to access network 103, which is referred to as a handover. The desire for a handover may be for a variety of reasons. For instance, assume that access network 102 comprises a GSM network and access network 103 comprises a WiFi network. When the session is initiated, dual mode device 106 may only be in range of the GSM network (i.e., access network 102). As some later time, dual mode device 106 may move into range of the WiFi network (i.e., access network 103). Service through the WiFi network may be less expensive and may provide higher bandwidth than the GSM network, so dual mode device 106 determines that a transfer from the GSM network to the WiFi network would be beneficial. Such logic may be programmed in dual mode device 106 or initiated by the user of dual mode device 106.

To initiate the transfer, dual mode device 106 may transmit a session initiation message (e.g., SIP INVITE) to IMS network 110 through access network 103. S-CSCF 112 receives the session initiation message, and communicates with handover application server 114 to establish a second session leg between dual mode device 106 and endpoint 140 using access network 103 as the means of access to IMS network 110. The session continues uninterrupted over the second session leg.

At initiation of the second session leg, a network element in IMS network 110 will assign another charging identifier (e.g., an ICID) to the session. For example, if dual mode device 106 initiates the session with a session initiation message (e.g., SIP INVITE), then a P-CSCF (not shown), a media gateway (not shown), or another element receiving the session initiation message will assign another charging identifier. The charging identifier that is assigned responsive to a handover is referred to herein as the handover charging identifier.

As described in the Background, if the network elements in IMS network 110 generate charging messages as described above, some of the network elements will generate charging messages that include the handover charging identifier instead of the original charging identifier, which causes problems. The following embodiments provide improved methods and systems for charging for the session that has been transferred from access network 102 to access network 103.

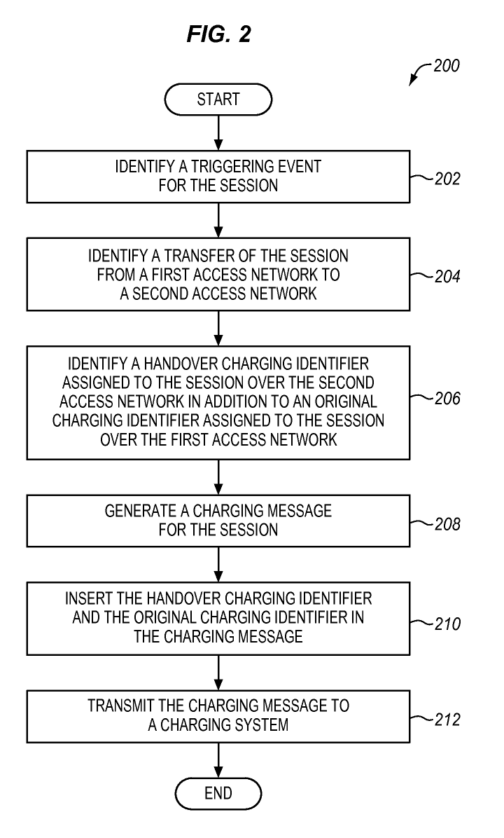

FIG. 2 is a flow chart illustrating a method 200 of generating charging messages in network elements in IMS network 110 in an exemplary embodiment of the invention. The steps of method 200 will be described with reference to communication network 100 in FIG. 1. The steps of the flow chart in FIG. 2 are not all inclusive and may include other steps not shown.

In step 202 of method 200, a network element, such as S-CSCF 112 or handover application server 114, identifies a triggering event for charging during the session, such as based on a Charging Trigger Function (CTF). In step 204, the network element identifies a transfer of the session from access network 102 to access network 103. A network element may identify the transfer of the session in a variety of ways. For example, handover application server 114 provides the service of handling handovers in IMS network 110. Thus, handover application server 114 is able to identify a transfer of the session from access network 102 to access network 103 based on signaling received for the session. Handover application server 114 may provide an indication of the transfer to other network elements.

In step 206, the network element identifies the handover charging identifier assigned to the session over access network 102 (i.e., the second session leg) in addition to the original charging identifier assigned to the session over access network 103 (i.e., the first session leg). The network element may identify the handover charging identifier in a variety of ways. For example, handover application server 114 maintains a database entry for the session for dual mode device 106. The database entry may include the directory numbers for dual mode device 106, the present status of dual mode device 106, etc. Handover application server 114 may also maintain a list of charging identifiers assigned to the session, such as the original charging identifier and one or more handover charging identifiers. Handover application server 114 may then use this list to identify the original charging identifier and the handover charging identifier for the session, and may also provide this information to other network elements in IMS network 110.

In steps 208 and 210, the network element generates a charging message for the session, and inserts the handover charging identifier and the original charging identifier in the charging message. When inserting the original charging identifier in the charging message, the charging message will have a parameter already designated for original charging identifier. For example, in a Diameter ACR message, there is an attribute value pair (AVP) designated for the original charging identifier. To insert the handover charging identifier, a new parameter may be designated for the handover charging identifier. For example, a new AVP in a Diameter ACR message may be designated for the handover charging identifier. In step 212, the network element transmits the charging message to charging system 116.

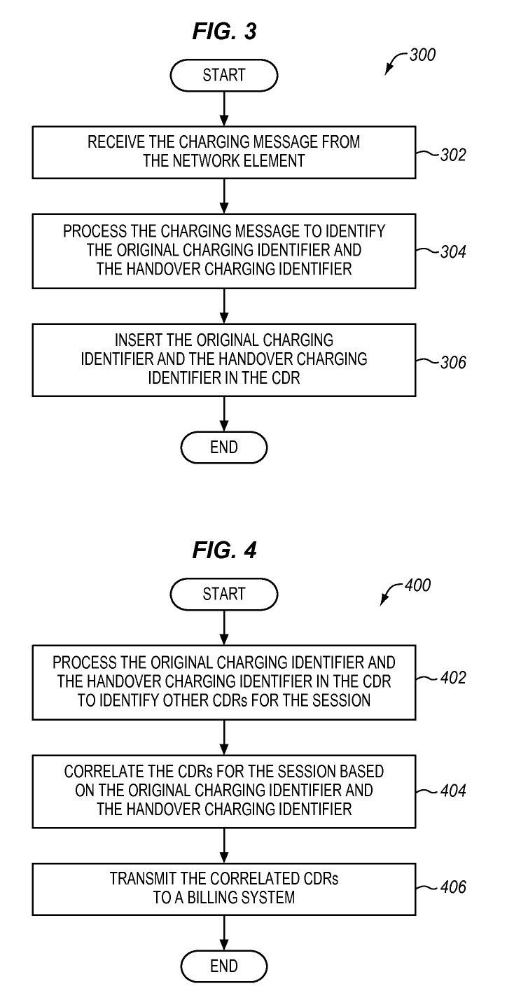

FIG. 3 is a flow chart illustrating a method 300 of processing charging messages in charging system 116 to generate CDRs in an exemplary embodiment of the invention. The steps of method 300 will be described with reference to communication network 100 in FIG. 1. The steps of the flow chart in FIG. 3 are not all inclusive and may include other steps not shown.

In step 302 of method 300, charging system 116 receives the charging message from the network element (i.e., S-CSCF 112 or handover application server 114). Charging system 116 may additionally receive charging messages from other network elements. In step 304, charging system 116 processes the charging message to identify the original charging identifier and the handover charging identifier. In step 306, charging system 116 inserts the original charging identifier and the handover charging identifier in a Charging Data Record (CDR) for the session. When inserting the original charging identifier in the CDR, the CDR will have a field already designated for original charging identifier. To insert the handover charging identifier, a new field may be designated in the CDR for the handover charging identifier. Charging system 116 then inserts the handover charging identifier in the new CDR field.

Step 306 assumes that a CDR is already open for this network element or for this dialog involving the network element. If a CDR is not already open, then charging system 116 opens the CDR. Those skilled in the art will appreciate that charging system 116 will close the CDR at some point. For instance, charging system 116 may receive a stop charging message, such as an ACR[stop] message, which causes charging system 116 to close the CDR.

Charging system 116 will most likely generate multiple CDRs for the session based on charging messages received from multiple network elements. Charging system 116 also provides the function of correlating CDRs for the session when the session is terminated. Because at least one of the CDRs include both the original charging identifier and the handover charging identifier, charging system 116 is able to effectively correlate the CDRs as described below.

FIG. 4 is a flow chart illustrating a method 400 of correlating CDRs in charging system 116 in an exemplary embodiment of the invention. The steps of method 400 will be described with reference to communication network 100 in FIG. 1. The steps of the flow chart in FIG. 4 are not all inclusive and may include other steps not shown.

In step 402 of method 400, charging system 116 processes the original charging identifier and the handover charging identifier in the CDR to identify other CDRs for the session having one or both of the original charging identifier and the handover charging identifier. For example, charging system 116 may be programmed to process the field in the CDR for the original charging identifier, and also process the field in the CDR for the handover charging identifier. When the charging identifiers are determined for the session, charging system 116 is able to identify all other CDRs that include the same charging identifiers, as these CDRs belong to the same session.

In step 404, charging system 116 correlates the CDRs for the session based on the original charging identifier and the handover charging identifier. Correlating the CDRs means forming some type of association between the CDRs so that they may be processed in a billing domain to provide billing for the session. Some of the CDRs for the session may not have both the original charging identifier and the handover charging identifier. For example, the CDRs that were generated prior to the handover will have the original charging identifier. Some of the CDRs that were generated after the handover may have only the original charging identifier or only the handover charging identifier. However, as long as one or more of the CDRs generated for the session include both the original charging identifier and the handover charging identifier, then charging system 116 has the proper information to correlate the CDRs for the session.

In step 406, charging system 116 transmits the correlated CDRs to billing system 120. Billing system 120 may then process the correlated CDRs to generate a bill for the session.

If another handover occurs from access network 103 to yet another access network which is not shown in FIG. 1, then a similar process is performed to report the new handover charging identifier to charging system 116. Charging system 116 will then be able to correlate CDRs based on the original charging identifier, the first handover charging identifier, and the second handover charging identifier.

The above methods provide an effective way of correlating charging information and CDRs for a session where handover has occurred from access network 102 to access network 103. Because both the original charging identifier and the handover charging identifier are reported to charging system 116 and inserted in one or more CDRs, charging system 116 is able to identify CDRs for the same session even though the CDRs may have different charging identifiers. As a result, more accurate charging may be realized for the session.

In addition to reporting the handover charging identifier to charging system 116, the network element may also provide additional handover information to charging system 116. One type of handover information that may be reported is a handover timestamp (i.e., a time when the handover occurred). For example, in step 206 of FIG. 2, the network element may additionally identify a timestamp of the transfer of the session from access network 102 to access network 103, which is referred to herein as a handover timestamp. In step 210, the network element may insert the handover timestamp in the charging message. To insert the handover timestamp, a new parameter may be designated in the charging message. For example, a new AVP in a Diameter ACR message may be designated for the handover timestamp.

Charging system 116 then processes the handover timestamp in the charging message, and inserts the handover timestamp in the CDR. To insert the handover timestamp, a new field may be designated in the CDR, and charging system 116 inserts the handover timestamp in the new CDR field. The handover timestamp may then be used in billing system 120 to adjust billing based on how long each access network 102-103 is used. For example, a GSM network may be billed at a higher rate than a WiFi network, so the billing is adjusted depending on how long the session was over the GSM network versus how long the session was over the WiFi network.

Another type of handover information that may be reported is a handover indication (i.e., indicating that the transfer is from one type of access network to another type of access network). For example, in step 210 in FIG. 2, the network element may also insert a handover indicator in the charging message indicating the transfer of the session from access network 102 to access network 103. The handover indication may be in variety of forms. For instance, the handover indication may indicate that the session has been seamlessly handed over from a GSM network to a WiFi network, from a WiFi network to a CDMA network, etc. To insert the handover indication, a new parameter may be designated in the charging message. For example, a new AVP in a Diameter ACR message may be designated for the handover indication.

Charging system 116 then processes the handover indication in the charging message, and inserts the handover indication in the CDR. To insert the handover indication, a new field may be designated in the CDR, and charging system 116 inserts the handover indication in the new CDR field. The handover indication may then be used in billing system 120 for a variety of reasons.

### Example

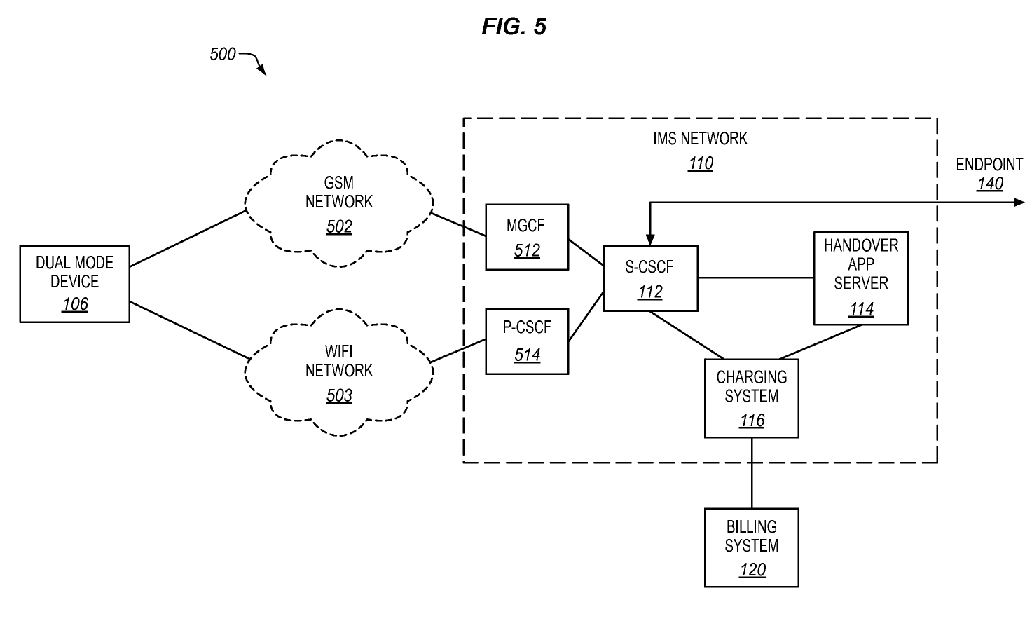

FIGS. 5-8 illustrate an example of charging for a session that is seamlessly handed over from one access network to another access network. FIG. 5 illustrates a communication network 500 in an exemplary embodiment of the invention. Communication network 500 includes a GSM network 502, a WiFi network 503, and IMS network 110. The IMS network 110 in FIG. 5 further includes a media gateway control function (MGCF) 512 and a P-CSCF 514. The example in FIGS. 5-8 illustrates a seamless handover from GSM network 502 to WiFi network 503 when dual mode device 106 is invited to a session by endpoint 140.

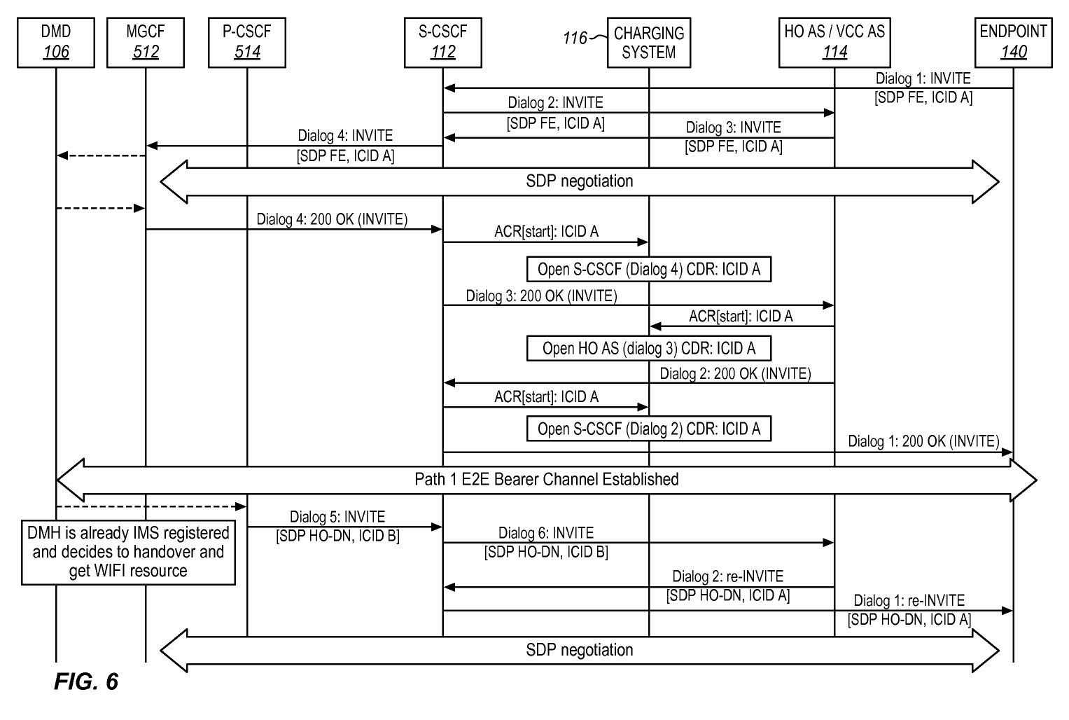

FIGS. 6-8 are message diagrams illustrating messaging used in the session in an exemplary embodiment of the invention. The message diagram illustrates SIP and Diameter messaging used within communication network 500, although other protocols may be used in other embodiments. Assume that an IMS endpoint 140 (see FIG. 5) wants to initiate a session with dual mode device 106 (DMD).

To initiate the session in FIG. 6, endpoint 140 generates a SIP INVITE message and transmits the INVITE message to the appropriate network element in IMS network 110. The network element receiving the INVITE message assigns an original ICID for the session, and the INVITE is ultimately forwarded to S-CSCF 112. The INVITE message (dialog 1) includes a session description that is designated by endpoint 140 (illustrated as SDP FE) in FIG. 6. The INVITE message also includes the original ICID for the session (indicated as ICID “A” in FIG. 6) which is inserted in the P-Charging-Vector of the INVITE message. Responsive to the INVITE message inviting dual mode device 106 to a session, S-CSCF 112 processes initial filter criteria (iFC) for dual mode device 106, which indicates that dual mode device 106 has dual mode functionality. Thus, S-CSCF 112 includes handover application server 114 (HO AS/VCC AS) in the session by transmitting a SIP INVITE message to handover application server 114 (dialog 2).

Handover application server 114 is a back-to-back user agent (B2BUA) in this embodiment (as is S-CSCF 112), so handover application server 114 transmits a SIP INVITE message (dialog 3) back to S-CSCF 112. S-CSCF 112 then transmits an INVITE message to a BGCF (not shown) which further routes the INVITE message to MGCF 512. MGCF 512 converts the INVITE message to the appropriate signaling message used in GSM network 502, and transmits the signaling message to dual mode device 106. At this point, dual mode device 106 and endpoint 140 may perform SDP negotiation.

Dual mode device 106 then transmits an acceptance of the session to MGCF 512 responsive to which MGCF 512 generates a SIP 200 OK message (dialog 4) and transmits the 200 OK message to S-CSCF 112. The 200 OK message in S-CSCF 112 is a trigger for the CTF in S-CSCF 112. Thus, S-CSCF 112 generates a Diameter ACR[start] message for dialog 4, inserts the original ICID (ICID “A”) in the ACR[start] message, and transmits the ACR[start] message to charging system 116. Responsive to the ACR[start] message, charging system 116 opens a CDR for S-CSCF 112 (dialog 4) and inserts ICID A into the CDR.

S-CSCF 112 also transmits the 200 OK message to handover application server 114. The 200 OK message in handover application server 114 is also a trigger for the CTF in handover application server 114. Thus, handover application server 114 generates a Diameter ACR[start] message for dialog 3, inserts the original ICID (ICID “A”) in the ACR[start] message, and transmits the ACR[start] message to charging system 116. Responsive to the ACR[start] message, charging system 116 opens a CDR for handover application server 114 (dialog 3) and inserts ICID A into the CDR.

Handover application server 114 then transmits a 200 OK message (dialog 2) back to S-CSCF 112. Responsive to the 200 OK message, S-CSCF 112 generates a Diameter ACR[start] message for dialog 2, inserts the original ICID (ICID “A”) in the ACR[start] message, and transmits the ACR[start] message to charging system 116. Responsive to the ACR[start] message, charging system 116 opens a CDR for S-CSCF 112 (dialog 2) and inserts ICID A into the CDR. S-CSCF 112 then transmits the 200 OK message to endpoint 140. The bearer channel is then established for the session, which is typically a Realtime Transport Protocol (RTP) channel. Dual mode device 106 and endpoint 140 may then communicate during the session via voice, text, multimedia, etc. There are four dialogs established to set up and maintain the session. These four dialogs (1-4) represent a first session leg.

The session at this point is over GSM network 502 which is acting as the access network (see FIG. 5). Assume further for this embodiment that dual mode device 106 comes into the service area of WiFi network 503 and registers with WiFi network 503. Dual mode device 106 may be programmed to request a transfer (or handover) from a GSM network 502 to a WiFi network 503 due to cost considerations, bandwidth considerations, etc.

To initiate the handover, dual mode device 106 transmits a SIP INVITE message to P-CSCF 514 through WiFi network 503. P-CSCF 514 assigns another ICID to the session, which is referred to as the handover ICID (ICID “B” in FIG. 6). P-CSCF 514 then transmits the INVITE message to S-CSCF 112. The INVITE message (dialog 5) includes a session description that is designated by dual mode device 106 (illustrated as SDP HO-DN) in FIG. 6. The INVITE message also includes the handover ICID for the session (indicated as ICID “B” in FIG. 6) which is inserted in the P-Charging-Vector of the INVITE message. Responsive to the INVITE message inviting dual mode device 106 to a session, S-CSCF 112 processes the initial filter criteria (iFC) for dual mode device 106, which indicates that dual mode device 106 has dual mode functionality. Thus, S-CSCF 112 includes handover application server 114 (HO AS) in the session by transmitting a SIP INVITE message to handover application server 114 (dialog 6).

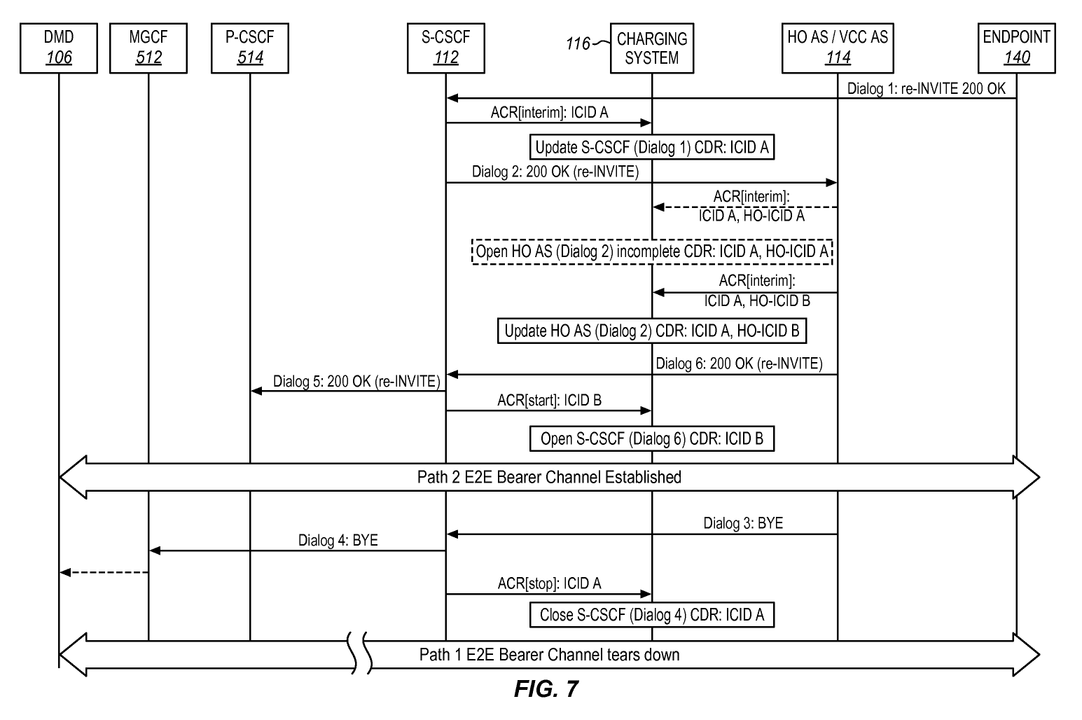

Handover application server 114 transmits a SIP re-INVITE message (dialog 2) back to S-CSCF 112. S-CSCF 112 then transmits a re-INVITE message (dialog 1) to endpoint 140. At this point, dual mode device 106 and endpoint 140 may perform SDP negotiation. In FIG. 7, endpoint 140 responds with a 200 OK (dialog 1) message to S-CSCF 112. In response to the 200 OK message, S-CSCF 112 generates a Diameter ACR[interim] message for dialog 1, inserts the original ICID (ICID “A”) in the ACR[interim] message, and transmits the ACR[interim] message to charging system 116. Responsive to the ACR[interim] message, charging system 116 updates the CDR for S-CSCF 112 (dialog 1). Even though a handover ICID has been assigned to the session, the dialogs 1-4 of the first session leg still use the original ICID.

S-CSCF 112 also transmits the 200 OK message to handover application server 114. Handover application server 114 identifies a triggering event for the session, which is the receipt of the 200 OK message. Handover application server 114 also identifies a transfer of the session from the GSM network 502 to WiFi network 503. For instance, when handover application server 114 receives the INVITE from S-CSCF 112 to transfer the session to WiFi network 503 (see FIG. 6), handover application server 114 may update a database entry for dual mode device 106 indicating that the session has been handed over, the time when the session was handed over, that the session was handed from a GSM network 502 to a WiFi network 503, etc. Responsive to a determination that the session has been handed over, handover application server 114 identifies the handover ICID and the original ICID for the session. Handover application server 114 then generates a Diameter ACR[interim] message for dialog 2, inserts the original ICID (ICID “A”) and the handover ICID (ICID “B”) in the ACR[interim] message, and transmits the ACR[interim] message to charging system 116. A new parameter may be designated in the ACR message for the handover ICID. For example, a new AVP in the ACR[interim] message and other ACR messages may be designated for the handover ICID. Responsive to the ACR[interim] message, charging system 116 updates a CDR for handover application server 114 (dialog 2) and inserts ICID A and ICID B into the CDR.

One assumption here is that a CDR for handover application server 114 (dialog 2) has already been opened. For instance, before handover application server 114 transmits the ACR[interim] message to charging system 116 responsive to the 200 OK message, handover application server 114 may send an ACR[interim] responsive to a time limit expiration. Prior to the 200 OK message for dialog 2, handover application server 114 may generate an ACR[interim] message, insert the original ICID (ICID “A”) in the ACR[interim] message, and transmit the ACR[interim] message to charging system 116. Responsive to the ACR[interim] message, charging system 116 opens an incomplete CDR for handover application server 114 (dialog 2) and inserts ICID A into the CDR.

Handover application server 114 then transmits a 200 OK message (dialog 6) to S-CSCF 112. Responsive to the 200 OK message, S-CSCF 112 generates a Diameter ACR[start] message for dialog 6, inserts the handover ICID (ICID “B”) in the ACR[start] message, and transmits the ACR[start] message to charging system 116. Responsive to the ACR[start] message, charging system 116 opens a CDR for S-CSCF 112 (dialog 6) and inserts ICID B into the CDR. S-CSCF 112 then transmits the 200 OK message (dialog 5) to P-CSCF 514, which in turn forwards the 200 OK message to dual mode device 106. The bearer channel is then established for the session, with the session now being over WiFi network 503 which is acting as the access network (see FIG. 5). Dual mode device 106 and endpoint 140 may then communicate during the session via voice, text, multimedia, etc. There are two additional dialogs established to set up and maintain the session. These two dialogs (5-6) represent a second session leg.

After the second session leg is established and the handover is completed, handover application server 114 initiates the tear down the dialogs over GSM network 502. Handover application server 114 thus generates a SIP BYE message (dialog 3), and transmits the BYE message to S-CSCF 112. S-CSCF 112 forwards the BYE message (dialog 4) to MGCF 512. MGCF 512 converts the BYE message to the appropriate signaling message used in GSM network 502, and transmits the signaling message to dual mode device 106.

Responsive to the BYE message, S-CSCF 112 generates a Diameter ACR[stop] message for dialog 4, inserts the original ICID (ICID “A”) in the ACR[stop] message, and transmits the ACR[stop] message to charging system 116. Responsive to the ACR[stop] message, charging system 116 closes the CDR for S-CSCF 112 (dialog 4), which includes only ICID A. The bearer channel for the session over GSM network 502 is then torn down.

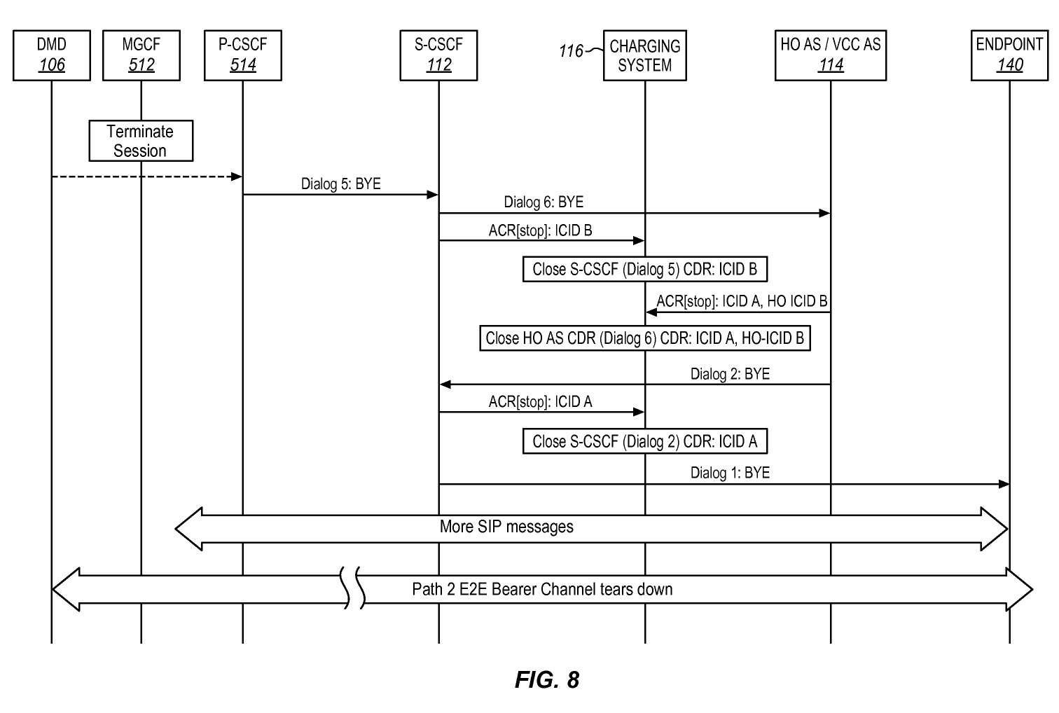

Assume at some later point that dual mode device 106 terminates the session, which is illustrated in FIG. 8. Dual mode device 106 terminates the session by generating a SIP BYE message and transmitting the BYE message to P-CSCF 514. P-CSCF 514 transmits the BYE message (dialog 5) to S-CSCF 112. In response to the BYE message, S-CSCF 112 transmits a BYE message (dialog 6) to handover application server 114. S-CSCF 112 also generates a Diameter ACR[stop] message for dialog 5, inserts the handover ICID (ICID “B”) in the ACR[stop] message, and transmits the ACR[stop] message to charging system 116. Responsive to the ACR[stop] message, charging system 116 closes the CDR for S-CSCF 112 (dialog 5), which includes only ICID B.

Handover application server 114 then identifies a triggering event for the session, which is the receipt of the BYE message. Handover application server 114 also identifies a transfer of the session from the GSM network 502 to WiFi network 503. Responsive to a determination that the session has been handed over, handover application server 114 identifies the handover ICID and the original ICID for the session. Handover application server 114 then generates a Diameter ACR[stop] message for dialog 6, inserts the original ICID (ICID “A”) and the handover ICID (ICID “B”) in the ACR[stop] message, and transmits the ACR[stop] message to charging system 116. Responsive to the ACR[stop] message, charging system 116 closes the CDR for handover application server 114 (dialog 6), which includes both ICID A and ICID B.

Handover application server 114 then responds to S-CSCF 112 with a BYE message for dialog 2). S-CSCF 112 generates a Diameter ACR[stop] message for dialog 2, inserts the original ICID (ICID “A”) in the ACR[stop] message, and transmits the ACR[stop] message to charging system 116. Responsive to the ACR[stop] message, charging system 116 closes the CDR for S-CSCF 112 (dialog 2), which includes only ICID A. S-CSCF 112 also transmits a BYE message (dialog 1) to endpoint 140. Additional SIP messages may then be exchanged to tear down the second session leg and end the session.

When the session is terminated, charging system 116 will have generated multiple full CDRs for S-CSCF 112. The CDR(s) regarding the first session leg (dialogs 1-4) involving S-CSCF 112 will have only the original ICID (i.e., ICID A). The CDR(s) regarding the second session leg (dialogs 5-6) will have only the handover ICID (i.e., ICID B).

Charging system 116 will also have generated a full CDR for handover application server 114. The CDR for handover application server 114 will include both the original ICID and the handover ICID. Because handover application server 114 facilitates the transfer of the session from GSM network 502 to WiFi network 503, handover application server 114 is able to identify when a transfer occurred and also identify both the ICIDs that have been assigned to the session. Handover application server 114 may thus report both the ICIDs in an ACR message to charging system 116. Responsive to receiving the ACR message from handover application server 114, charging system 116 processes the ACR message to identify the original ICID and the handover ICID. A new CDR field may be designated for the handover ICID into which charging system 116 inserts the handover ICID.

After the session is terminated, charging system 116 is able to correlate the CDRs for the session using the original ICID and the handover ICID. For example, there may be multiple CDRs for S-CSCF 112, with some of the CDRs having the original ICID and some having the handover ICID. Similarly, there may be CDRs for MGCF 512 having the original ICID, and CDRs for P-CSCF 514 having the handover ICID. Charging system 116 processes the original ICID and the handover ICID in the CDR from handover application server 114 to identify other CDRs for the session that have either the original ICID or and the handover ICID. Charging system 116 then correlates the CDRs for the session based on the original ICID and the handover ICID. When the CDRs are correlated, charging system 116 transmits the correlated CDRs to billing system 120.

Although specific embodiments were described herein, the scope of the invention is not limited to those specific embodiments. The scope of the invention is defined by the following claims and any equivalents thereof.

We claim:

1. An IMS network adapted to provide charging for a session of a dual mode device that is transferred from a first access network to a second access network, the IMS network comprising:
a charging system; and
a network element adapted to identify a triggering event for charging during the session, to identify a transfer of the session from the first access network to the second access network, to identify a handover charging identifier assigned to the session over the second access network in addition to an original charging identifier assigned to the session over the first access network, to generate a charging message for the session and insert the handover charging identifier and the original charging identifier in the charging message, and to transmit the charging message to the charging system.

2. The IMS network of claim 1 wherein the network element is further adapted to:
insert a handover indicator in the charging message indicating the transfer of the session from the first access network to the second access network.

3. The IMS network of claim 2 wherein the network element is further adapted to:
identify a timestamp of the transfer of the session from the first access network to the second access network; and
insert the timestamp in the charging message.

4. The IMS network of claim 3 wherein the charging message comprises a Diameter charging message, and the network element is further adapted to:
insert the handover charging identifier in a first new attribute value pair (AVP) in the Diameter charging message;
insert the handover indicator in a second new attribute value pair (AVP) in the Diameter charging message; and
insert the timestamp in a third new attribute value pair (AVP) in the Diameter charging message.

5. The IMS network of claim 1 wherein the charging system is adapted to:
receive the charging message from the network element;
process the charging message to identify the original charging identifier and the handover charging identifier; and
insert the original charging identifier and the handover charging identifier in a Charging Data Record (CDR) for the session.

6. The IMS network of claim 5 wherein the charging system is further adapted to:
process the charging message to further identify additional handover information; and
insert the additional handover information in the CDR.

7. The IMS network of claim 6 wherein the additional handover information includes at least one of a handover timestamp and a handover indication.

8. The IMS network of claim 5 wherein the charging system is further adapted to:
process the original charging identifier and the handover charging identifier in the CDR to identify other CDRs for the session having at least one of the original charging identifier and the handover charging identifier;
correlate the CDRs for the session based on the original charging identifier and the handover charging identifier; and
transmit the correlated CDRs to a billing system.

9. A method of providing charging for a session of a dual mode device that is transferred from a first access network to a second access network, the method comprising:
identifying a triggering event for charging during the session;
identifying a transfer of the session from the first access network to the second access network;
identifying a handover charging identifier assigned to the session over the second access network in addition to an original charging identifier assigned to the session over the first access network;
generating a charging message for the session; and
inserting the handover charging identifier and the original charging identifier in the charging message.

10. The method of claim 9 further comprising:
inserting a handover indicator in the charging message indicating the transfer of the session from the first access network to the second access network.

11. The method of claim 10 further comprising:
identifying a timestamp of the transfer of the session from the first access network to the second access network; and
inserting the timestamp in the charging message.

12. The method of claim 11 wherein the charging message comprises a Diameter charging message, and the method further comprises:
inserting the handover charging identifier in a first new attribute value pair (AVP) in the Diameter charging message;
inserting the handover indicator in a second new attribute value pair (AVP) in the Diameter charging message; and
inserting the timestamp in a third new attribute value pair (AVP) in the Diameter charging message.

13. The method of claim 9 further comprising:
processing the charging message to identify the original charging identifier and the handover charging identifier; and
inserting the original charging identifier and the handover charging identifier in a Charging Data Record (CDR) for the session.

14. The method of claim 13 further comprising:
processing the charging message to further identify additional handover information; and
inserting the additional handover information in the CDR.

15. The method of claim 14 wherein the additional handover information includes at least one of a handover timestamp and a handover indication.

16. The method of claim 15 further comprising:
processing the original charging identifier and the handover charging identifier in the CDR to identify other CDRs for the session having at least one of the original charging identifier and the handover charging identifier; and
correlating the CDRs for the session based on the original charging identifier and the handover charging identifier.

17. An IMS network adapted to provide charging for a session, the IMS network comprising:
a charging system; and
a network element adapted to receive signaling for a first leg of the session identified by a first charging identifier, to initiate a second leg of the session identified by a second charging identifier, to generate a charging message for the session responsive to a triggering event, to insert the first charging identifier and the second charging identifier in the charging message, and to transmit the charging message to the charging system.

18. The IMS network of claim 17 wherein the charging system is adapted to:
receive the charging message from the network element;
process the charging message to identify the first charging identifier and the second charging identifier; and
insert the first charging identifier and the second charging identifier in a Charging Data Record (CDR) for the session.

19. The IMS network of claim 18 wherein the charging system is further adapted to:
process the first charging identifier and the second charging identifier in the CDR to identify other CDRs for the session having at least one of the first charging identifier and the second charging identifier;
correlate the CDRs for the session based on the first charging identifier and the second charging identifier; and
transmit the correlated CDRs to a billing system.

20. The IMS network of claim 17 wherein the network element comprises a handover application server adapted to initiate the second leg of the session responsive to a dual mode device transferring the session from a first access network to a second access network.
